(19) United States
(12) Patent Application Publication
(10) Pub. No.: US 2007/0206055 A1
(43) Pub. Date: Sep. 6, 2007

(54) Droplet Deposition Apparatus

(76) Inventors: Werner Zapka, Jarfalla (SE); Mark I. Crankshaw, Cambridge (GB); Stephen Temple, Cambridge (GB); Paul Drury, Hertfordshire (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/573,701

(22) PCT Filed: Sep. 27, 2004
(86) PCT No.: PCT/GB04/04136

§ 371 Date: Dec. 6, 2006

(30) Foreign Application Priority Data
Sep. 26, 2003 (GB) 03225590.1

(51) Int. Cl. B41J 2/045

(52) U.S. Cl. 347/54

(57) ABSTRACT

An inkjet printer has ink channels extending through a body, each channel being offset relative to a central plane with respect to the adjacent channel. A manifold extends through the body, intersecting each channel to define a channel end profile. The channel end profile of one channel is substantially a mirror image of the channel end profile of the adjacent channel, so that the acoustic was refection coefficient of the boundary between each channel and the manifold is substantially equal for all channels. An inclined region of the channel end profile facilitates the formation of connecting tracks for the channel electrodes.

The present invention relates droplet deposition apparatus and in an important example to ink jet print heads and—in particular—drop on demand ink jet print heads.

In industrial printing applications the throughput capability is often the key requirement. For inkjet printing the task to maximize the printed area per unit time can be addressed in different ways. A figure of merit for throughput capability of all these approaches is the total ink volume delivered by an individual nozzle in unit time. It will of course remain important for the output of the printer to be precisely and reliably uniform, whether over a printed page or from printed image to printed image.

In a known construction, channels are formed in a body of piezoelectric material and droplets of ink ejected, through the action of an acoustic wave in the ink channel, generated by deflection of the channel walls.

It has been proposed in EP-A-0 278 590 to offset alternate ink channels. Experiments have shown, however, that this offset can lead to variations in performance and particularly to differences in the velocity of ink ejection from neighboring, offset channels.

According to one aspect of the present invention, there is provided droplet deposition apparatus comprising a body structure defining a central plane and in that plane a channel extension direction; a plurality of elongate droplet ejection channels extending through the body structure parallel to the central plane and in the channel extension direction, each channel being offset relative to the central plane with respect to the adjacent channel; a respective droplet ejection nozzle communicating with each channel; actuating means for generating an acoustic wave in a selected channel and thereby effecting drop ejection through the respective nozzle; a manifold extending through the body structure parallel to the central plane and orthogonal to the channel extension direction, the manifold intersecting each channel to define a channel end profile, the channel end profile of one channel being substantially a mirror image in the central plane of the channel end profile of the adjacent channel, so that the acoustic wave refection coefficient of the boundary between each channel and the manifold is substantially equal for all channels.

The present applicants have determined that variation in acoustic wave reflectivity in offset channel arrangements is an important factor in droplet ejection velocity and this aspect of the present invention therefore provides the advantages of offset channels with much less—if any—variation in droplet ejection velocity

Advantageously, each channel end profile includes a profile surface which is inclined with respect to the channel extension direction, the angle of inclination of the profile surface for one channel being equal and opposite to that of the adjacent channel.

An inclined channel end profile assists considerably in the formation of conductive tracks connecting electrodes in each channel with circuitry providing drive waveforms. These electrically conductive tracks are conveniently formed by deposition of a continuous conductive layer and subsequent laser removal of material to delineate tracks.

In another aspect, the present invention consists in droplet deposition apparatus comprising a body structure defining a central plane and in that plane a channel extension direction; a plurality of elongate droplet ejection channels extending through the body structure parallel to the central plane and in the channel extension direction, a first group of channels being offset relative to the central plane in a first offset direction orthogonal to the central plane and a second group of channels being offset relative to the central plane in a second offset direction orthogonal to the central plane; a respective droplet ejection nozzle communicating with each channel; actuators comprising respective regions of piezoelectric material with electrodes connected to receive drive signals, each actuator on receipt of a drive signal serving to generate an acoustic wave in a selected channel and thereby effect drop ejection through the respective nozzle; a manifold extending through the body structure parallel to the central plane and orthogonal to the channel extension direction, the manifold intersecting each channel to define a channel end profile, with a conductive track extending over at least part of the channel end profile of each channel, these conductive tracks carrying drive signals to the electrodes, the channel end profile of the first group of channels being substantially a mirror image in the central plane of the channel end profile of the second group of channels, so that the acoustic wave refection coefficient of the boundary between each channel and the manifold is substantially equal for all channels.

Preferably, the cross section of the manifold is symmetric with respect to the central plane.

In yet a further aspect, the present invention consists in droplet deposition apparatus comprising a body structure defining a central plane and in that plane a channel extension direction; a plurality of elongate droplet ejection channels extending through the body structure parallel to the central plane and in the channel extension direction, a first group of channels being offset relative to the central plane in a first offset direction orthogonal to the central plane and a second group of channels being offset relative to the central plane in a second offset direction orthogonal to the central plane; a respective droplet ejection nozzle communicating with each channel; electrically actuable means for generating an acoustic wave in a selected channel and thereby effecting droplet ejection through the respective nozzle; a manifold extending through the body structure parallel to the central plane and orthogonal to the channel extension direction, the manifold intersecting each channel, with the first group of channels having an acoustic wave reflection coefficient at the manifold which differs from the acoustic wave reflection coefficient at the manifold of the second group of channels; a first electrical drive circuit for providing a first drive waveform for actuating channels of the first group of channels and a second electrical drive circuit for providing a second drive waveform for actuating channels of the second group of channels, the first and second groups of channels being actuated alternately and the first drive waveform differing from the second drive waveform in that extent necessary to ensure equal velocity of drop ejection from a channel of the first group and a channel of the second group.

Advantageously, the first drive waveform differs from the second drive waveform in drive voltage, in pulse rise or in pulse width.

In still a further aspect, the present invention consists in a method of droplet deposition comprising the steps of providing a body structure defining a central plane and in that plane a channel extension direction; a plurality of elongate droplet ejection channels extending through the body structure parallel to the central plane and in the channel extension direction, each channel being offset relative to the central plane with respect to the adjacent channel; a respective droplet ejection nozzle communicating with each channel; and a manifold extending through the body structure parallel to the central plane and orthogonal to the channel extension direction, the manifold intersecting each channel to define a channel end profile; generating an acoustic wave in a first channel and thereby effecting drop ejection through the respective nozzle; generating an acoustic wave in a second channel adjacent to the first channel and thereby effecting drop ejection through the respective nozzle; and arranging that the acoustic wave refection coefficient of the boundary between the first channel and the manifold is equal to that of the boundary between the second channel and the manifold.

In still a further aspect, the present invention consists in the use of droplet deposition apparatus comprising a body structure defining a central plane and in that plane a channel extension direction; a plurality of elongate droplet ejection channels extending through the body structure parallel to the central plane and in the channel extension direction, a first group of channels being offset relative to the central plane in a first offset direction orthogonal to the central plane and a second group of channels being offset relative to the central plane in a second offset direction orthogonal to the central plane; a respective droplet ejection nozzle communicating with each channel; electrically actuable means for generating an acoustic wave in a selected channel and thereby effecting droplet ejection through the respective nozzle; a manifold extending through the body structure parallel to the central plane and orthogonal to the channel extension direction, the manifold intersecting each channel, with the first group of channels having an acoustic wave reflection coefficient at the manifold which differs from the acoustic wave reflection coefficient at the manifold of the second group of channels; the use comprising the steps of alternately applying a first drive waveform to actuate selected channels of the first group of channels and a second drive waveform to actuate selected channels of the second group of channels, the first drive waveform differing from the second drive waveform in that extent necessary to ensure equal velocity of drop ejection from a channel of the first group and a channel of the second group.

Preferably, the first drive waveform differs from the second drive waveform in drive voltage, in pulse rise or in pulse width.

In one form, the present invention consists in droplet deposition apparatus comprising an actuator plate comprising a plurality of channels at a predetermined channel spacing, each of said channels having a predetermined length d1 a portion of said length having a constant depth and a portion of said length having a changing depth; a nozzle plate providing an end wall of said actuator channels and said cover channels; wherein said actuator channels comprise acoustic reflection modifying means.

In another form, the present invention consists in droplet deposition apparatus comprising an actuator plate comprising a plurality of channels at a predetermined channel spacing, each of said channels having a predetermined length d1 a portion of said length having a constant depth and a portion of said length having a changing depth; a cover plate comprising a plurality of channels at a predetermined channel spacing and having a channel length d2, where d2 is less than d1; at least one of said actuator channels being in registry with at least one of said cover channels; a nozzle plate providing an end wall of said actuator channels and said cover channels; wherein at least some of said actuator channels comprise acoustic reflection modifying means such that the acoustic reflection of an ejection channel formed of an actuator channel in registry with a cover channel is substantially identical to the acoustic reflection of an ejection channel formed of an actuator channel which is not in registry with a cover channel.

Advantageously, the acoustic reflection modifying means comprise a groove extending transverse to the length of the actuator channels, the groove being preferably filled with an ejection fluid or an acoustically transparent solid such as epoxy or other adhesive.

The present invention will now be described, by way of example only, with reference to the following diagrams in which:

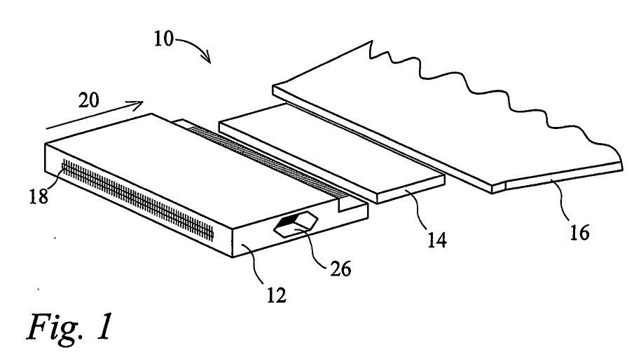

FIG. 1 is a schematic view of an ink jet printer according to one embodiment of the present invention;

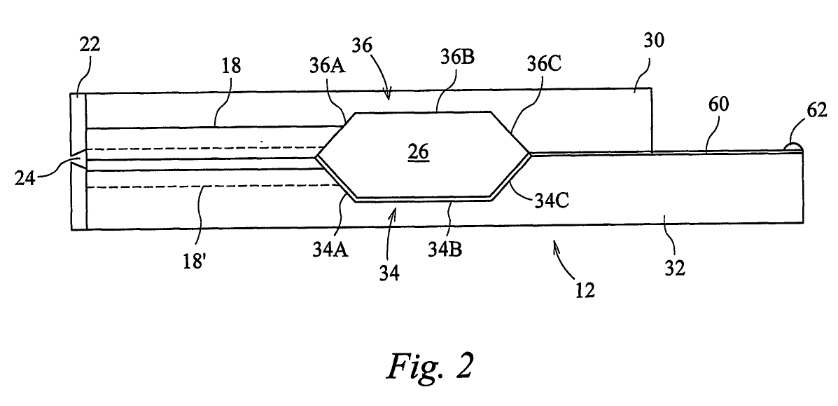

FIG. 2 is a section on an enlarged scale through part of the ink jet printer shown in FIG. 1;

FIGS. 3, 4 and 5 are diagrammatic views illustrating the relative disposition of key components;

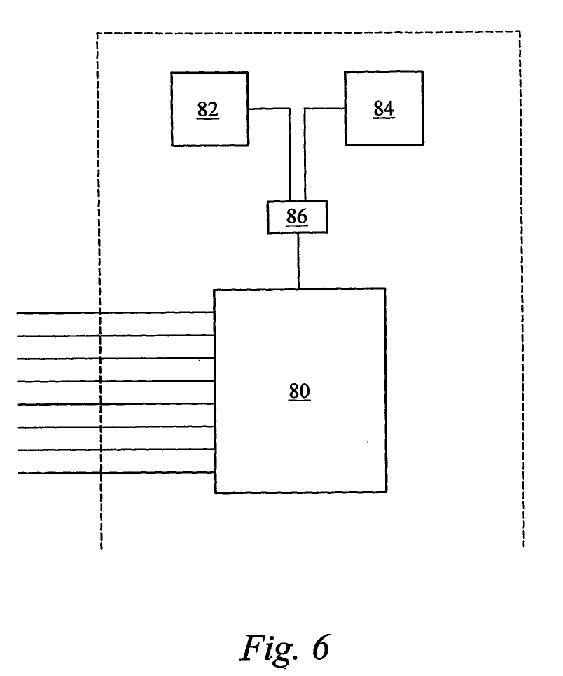

FIG. 6 is a block diagram illustrating drive circuitry;

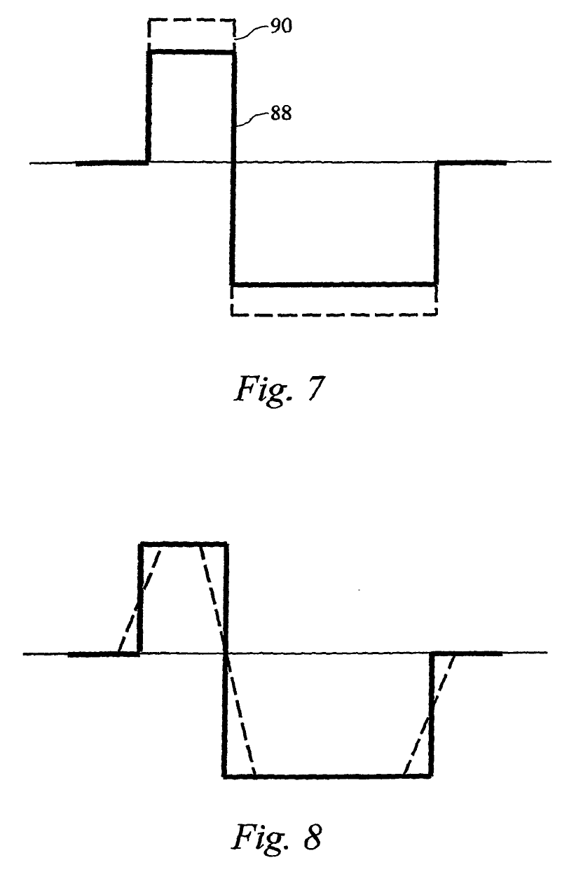

FIGS. 7, 8 and 9 are waveform diagrams illustrating alternative forms of operation of the drive circuitry of FIG. 6;

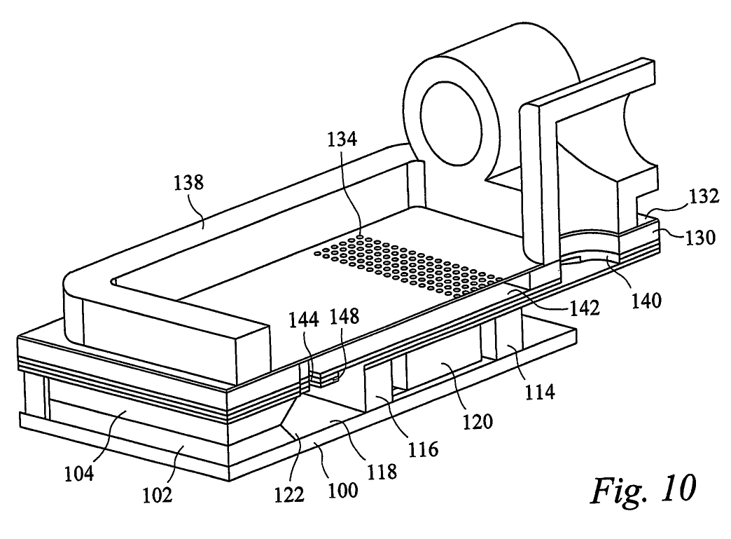

FIG. 10 is an isometric, cut-away view of a drop on demand ink jet printer according to a further embodiment of the present invention;

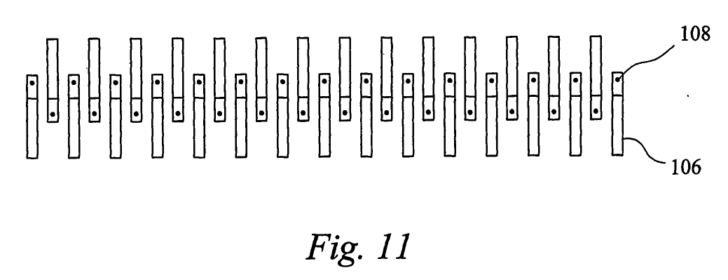

FIG. 11 is a diagram illustrating the disposition of channels and nozzles in the print head of FIG. 10;

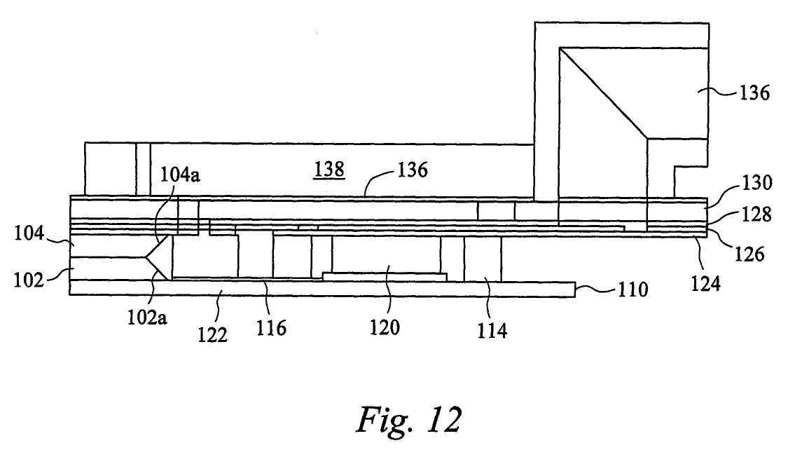

FIG. 12 is a side section through the print head of FIG. 10;

FIG. 13 is a top plan view of the print head of FIG. 10;

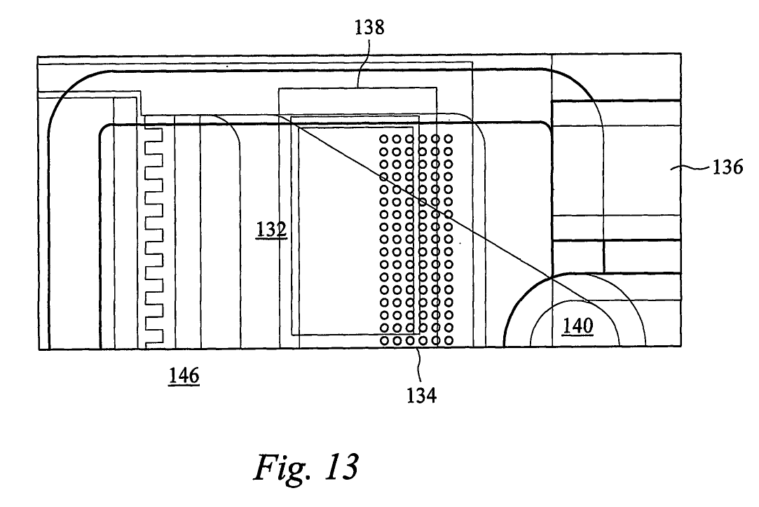

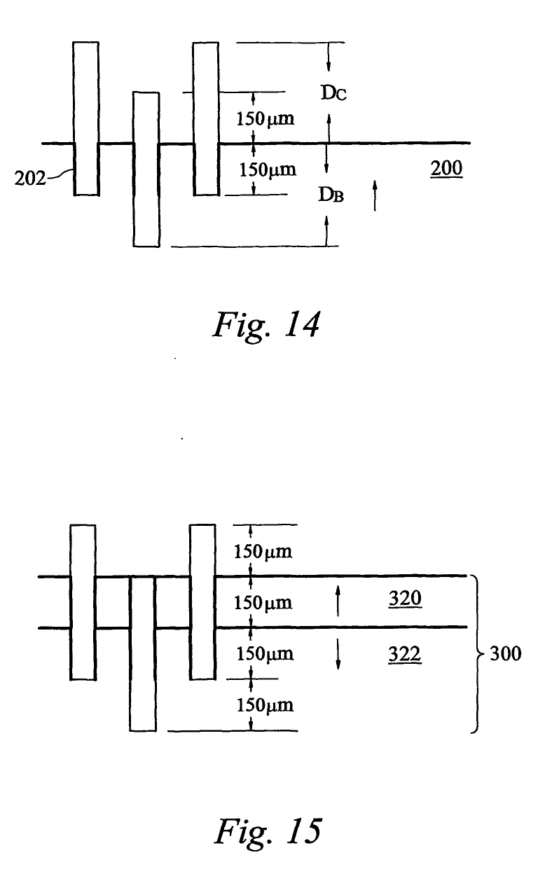

FIGS. 14 and 15 are diagrams illustrating different arrangements of offset channels;

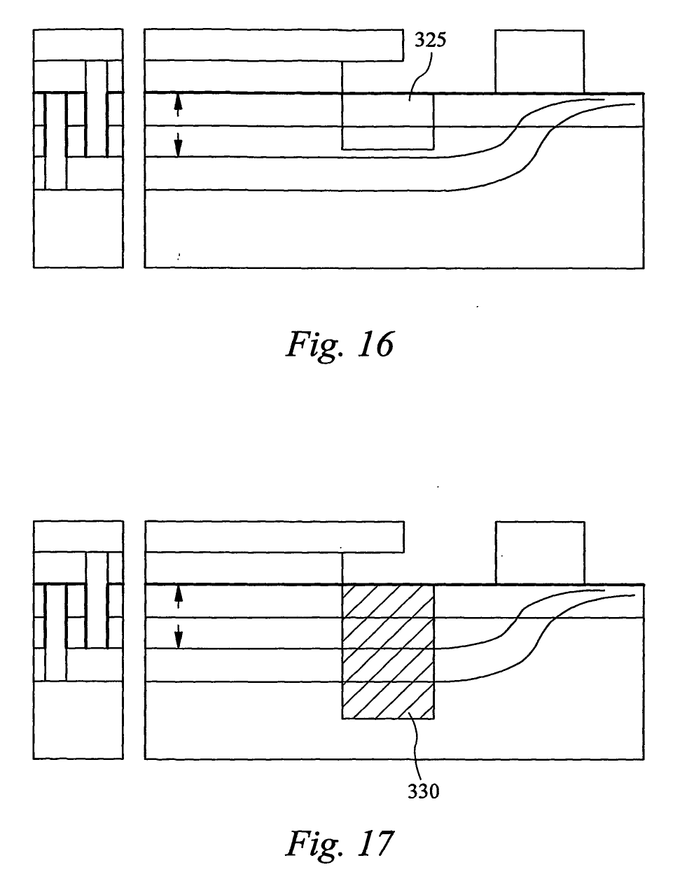

FIGS. 16 and 17 are diagrams illustrating alternative further forms of the invention; and

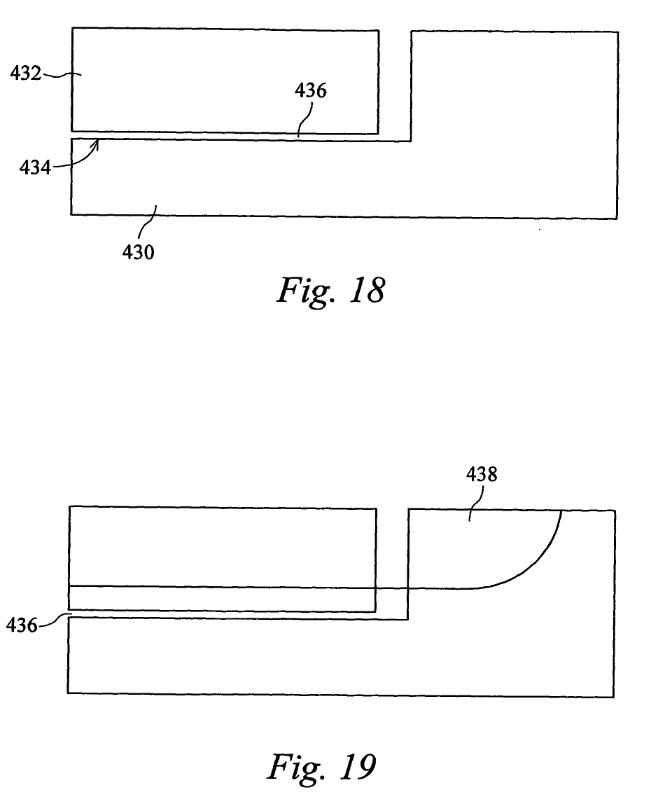

FIGS. 18, 19, 20 and 21 are diagrams illustrating the manufacture of constructions shown in FIGS. 16 and 17.

Referring initially to FIG. 1, a drop on demand ink jet printhead 10 comprises a body structure 12, an integrated circuit drive arrangement 14 and a printed circuit board 16. The body structure 12 is formed with a plurality of parallel ink channels 18 which extend in the direction shown by arrow 20. A nozzle plate 22 (seen in FIG. 2) is secured to the front edge of the body structure 12 and defines for each channel 18, an ink ejection nozzle 24. Each channel 18 extends from the associated nozzle 24 to an ink supply or removal manifold 26, which passes through the body structure 12 in a direction orthogonal to the arrowed direction 20.

As shown more clearly in FIG. 2, the body structure 12 is formed of top and bottom layers 30 and 32. In the simplest form, each of these layers 30, 32 is formed of poled piezoelectric material, such as PZT. It may be convenient for each of these two layers to be formed itself of a laminate, comprising PZT at the boundary between layers 30, 32 with a suitable backing substrate such as alumina or glass. The ink channels 18 are formed, for example by sawing the layers 30 and 32. As seen most clearly in FIGS. 5 and 6, neighbouring channels 18 are offset with respect to a central plane, defined in this example by the boundary between layers 30 and 32. Thus, a first group of the channels (being in one example the odd numbered channels) extend a relatively short distance into the layer 30 and a relatively long distance into the layer 32. A second group of channels (being in this example the even numbered channels) extend a relatively long distance into the layer 30 and a relatively short distance into the layer 32. In FIG. 2, the location with respect to the central plane of the even-numbered channels is shown in full lines marked 18, whilst the location of the odd-numbered channels is shown through dotted lines marked 18′.

The ink manifold 26 is formed by aligned and complementary grooves 34 and 36 cut or otherwise formed in the respective layers 32 and 30. Each of the grooves 34 and 36 has a front edge 34,36 A inclined at approximately 45 degrees to the direction 20, a flat base 34,36 B and a rear portion 34,36 C, similarly inclined at about 45 degrees.

Walls 50 of piezoelectric material (see for example FIG. 5) are defined between adjacent channels 18 and, as is now well known in the art, these walls of piezoelectric material serve as actuators to effect the ejection of an ink droplet through the nozzle 24 of the associated channel 18. More specifically, electrode 52 provided on the inside walls of the channels at or near the intersection plane of the layers 30 and 32, enable the application of a field across oppositely poled regions of piezoelectric material causing the walls to deform in chevron formation. [See for example EP-A-0 277 703 and EP-A-0 278 590.]

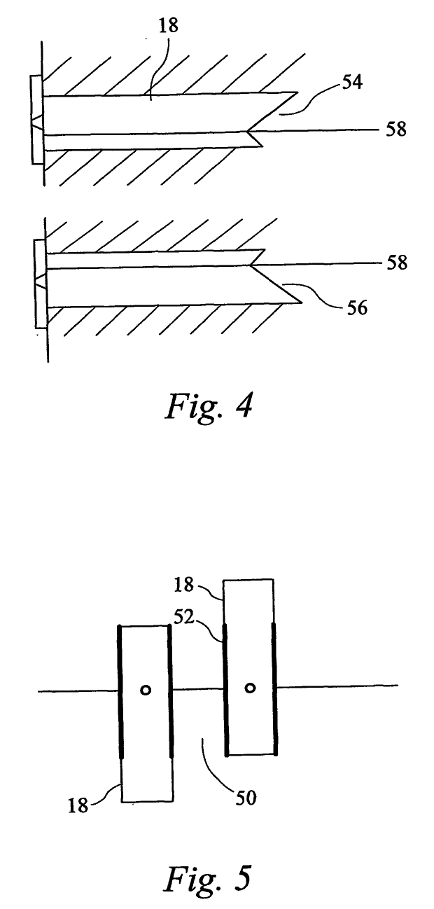

With the application of appropriate drive signals to the electrodes 52, an acoustic wave is caused to travel along the selected ink channel resulting in the ejection of a droplet of ink. The behaviour of this acoustic wave in the ink channel at the end of the channel defined by the nozzle plate 22 and the end of the channel defined by the manifold 26 is crucial to the correct and reliable performance of the printhead. The two groups of channels (that is to say in this case the odd-numbered and the even-numbered channels) have as a result of their respective offset different intersections with the manifold 26 and accordingly different channel end profiles. FIG. 3 shows schematically an even-numbered channel with its corresponding channel end profile 54; Figure similarly shows an odd-numbered channel with its channel end profile 56. Also shown in both FIGS. 3 and 4 is a line 58 designating the plane of intersection of the layers 30 and 32 or a central plane. It will be observed however that the channel end profiles of the two groups of channels are mirror images of each other in that central plane. This has the very important result that the acoustic reflection coefficient of the two groups of channels at the ink manifold 26 is substantially identical across all channels despite the differing offsets.

Ensuring in this way that the acoustic wave is reflected at the manifold in the same manner across all channels, is a key factor in providing uniform ejection velocity.

The inclined surfaces 34A, which provide a relatively large part of the channel end profile of the odd-numbered group of channels and a relatively small art of the even-numbered group of channels, serves a most useful purpose. They allow tracks 60 which extend from the electrodes 50 to wire bonds sites 62 for connection to the integrated circuit, to be formed using simple and reliable processes. Thus in one example, the tracks can be formed by deposition of suitable metallic material onto the layer 32 with subsequent laser processing to remove metallic material and leave tracks which are closely spaced yet reliably isolated one from the other. Electroless nickel metallisation is a useful technique for forming a continuous layer. It will be understood that an ink manifold which presented a vertical face to the ink channel would not readily permit such techniques.

In an arrangement in which identity of acoustic wave reflection cannot with sufficient precision be assured, it will be possible as shown in FIG. 6 to provide for the two groups of channels to be driven with different waveforms to compensate for any variation in acoustic wave reflection and thereby still assure uniform velocity of droplet ejection. Thus a drive circuit 80 with multiple connections 82 to the respective wire bond sites 62, is provided with two drive waveform generators 82 and 84. A flip-flop 86 serves to provide the outputs of these two waveform generators alternately to the drive circuit 80.

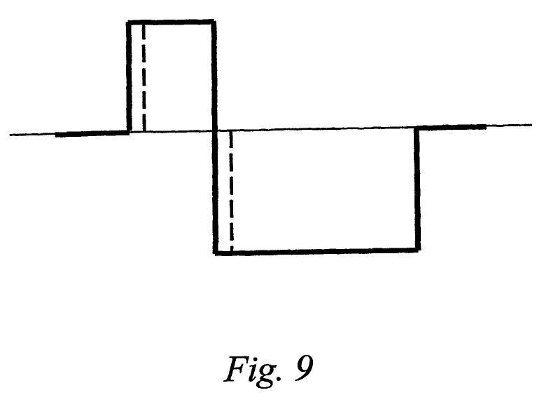

The drive circuit is arranged to actuate the two groups of channels sequentially and the flip-flop 86 operates to multiplex the two waveforms in synchronism. The two waveforms may differ in a variety of ways. They may for example differ as to the drive voltage; this is illustrated in FIG. 7 where one waveform is shown in full line 88 and the other in dotted line 90. An alternative is shown in FIG. 8 in which the waveforms differ as to pulse rise or pulse rise and fall. In the arrangement depicted in FIG. 9, the waveforms differ in pulse width.

Referring now to FIGS. 10, 11 and 12, there is described a further embodiment of an inkjet printer according to the present invention.

On a base 100 of alumina or other appropriate material is formed a first layer 102 of piezoelectric material. Above this layer is formed a second layer of piezoelectric material 104. Ink channels 106 are cut or otherwise formed in these two piezoelectric layers 102, 104, in a manner analogous to that described with reference to previous figures.

The offset arrangement of channels 106 is shown in FIG. 11, which also shows nozzles 108. In this case, the nozzles are themselves offset. This is an option which can be used in a variety of embodiments of the invention to compensate for any separation on the printed medium of droplets ejected from different groups of channels.

A bulkhead frame 110—conveniently formed of injected moulded plastics—is formed on the base 100, this bulkhead frame comprising two parallel end members 112 (only one of which is seen in FIG. 10), and two parallel cross-members 114 and 116. The bulkhead cross-member 116 faces the inner edge surfaces of the piezoelectric layers 102 and 104 and with those edge surfaces define an ink manifold 118. The edge surface 102a of the piezoelectric layer 102 is inclined at an angle of approximately 45° to the base 100. The edge surface 104a of the piezoelectric layer 104 is inclined at an equal and opposite angle.

An integrated circuit 120 is housed between the bulkhead cross-members 114 and 116. This integrated circuit houses the drive circuitry for the actuable walls defined between adjacent ink channels and described in more detail with the preceding embodiment. Conductive tracks 122 extend across the upper surface of the base 100, beneath the bulkhead cross-member 116, across that part of the base 100 which bounds the ink manifold 118 and up the inclined surface 102a, to connect with electrodes formed within the ink channels.

A stack of metallic or plastics foils 124, 126 and 128 extends across the printer. On top of this stack is positioned a spacer layer 130 of typically plastics material and a metallic filter plate 132 sits on top of this spacer layer. A bank of fine ink inlet apertures 134 are formed in the filter plate 132. An ink inflow is provided through port 136 with its associated frame 138. An ink outlet port 138 communicates with a relatively large aperture 140 formed in the filter plate 132 as well as stack layers 126 and 128. Beneath the filter plate 132, a cutaway region 142 is provided in the spacer layer 130. This cutaway region communicates with the ink manifold 118 by means of a transverse slot 144 cut through the stack 124, 126 and 128. From the end of the printhead adjacent the piezoelectric material, fingers 146 extend into the slot 142. These fingers are seen more clearly in FIG. 11 and are formed through the spacer layer 130 and three stack layers 124, 126 and 128. Along the opposite end of the slot 144, a step 148 is formed by removal of the layers 124 and 126. Extending rearwards from this step, across the bulkhead number 116 and over the integrated circuit 120 and the bulkhead number 114, an ink outlet path is defined by removal of the layer 126. This path communicates with the aperture 140. It will be seen that in this way, ink flows through inlet port 136, through filter apertures 134, across cutaway region 142 and through slot 144, essentially between fingers 146 and step 148. Ink passes from the manifold 118 through the path defined by removal of layer 126 to aperture 140 and outlet port 138.

It will be recognized that there are many alternatives of supply ink to an from the manifold.

It is helpful to look more closely at the offset channel dimensions.

FIG. 14 depicts an arrangement in which only one of the two previously described layers is formed of piezoelectric material, this being the actuator plate 200. Electrodes 202 are formed on the walls of the actuator plate using a directional vacuum deposition process. As depicted, this results in a coating which extends over different sections of the ejection channel depending on the depth of the channel formed in the actuator plate. Where a greater depth of channel is provided by the actuator channel then the electrode extend over a central portion of the channel. Where a smaller depth of the channel is provided by the channel in the actuator plate then the plating extends to the base of the channel.

Upon operation of the actuator of FIG. 14 and where D_{B}=D_{C} i.e. the depth of each of the channels was 450 μm with alternate channels extending 300 μm into the actuator plate 200 component and 150 μm into the cover 204; and 300 μm into the cover and 150 μm into the actuator component respectively, it was found that the velocity of droplets varied significantly depending which channel ejected it. The applicant believes that the higher efficiency of the upper channel is caused, in part, by a greater acoustic reflection coefficient at the end of the cover channel. The end of the cover channel terminates with a straight edge opening into an ink supply manifold and this provides an efficient acoustic boundary. As explained and as known in the prior art, an acoustic wave is initiated in the ejection channel upon movement of the actuator walls. The wave travels rearwardly along the channel and is reflected at an acoustic boundary at a time that is a function of the speed of sound in the ink. The acoustic wave then travels forwardly along the channel—and may be reinforced by further movement of the actuator walls—and a droplet is ejected at an appropriate timing. An acoustic boundary is provided wherever there is a change in acoustic impedance for example a change in ink depth or a sudden opening of a high impedance channel into a low impedance chamber. Other forms of acoustic boundary are well known in the prior art. It is believed that the straight edge, orthogonal to the direction of channel length, of the end of the cover channel reflects the acoustic wave more efficiently than the acoustic boundary provided by the actuator channels. A number of print heads were formed which had an overall channel depth of 550 μm but with varying depth of cover and actuator channels. It was found that, surprisingly, the velocity of the ink drop ejected from channels which extend a greater distance into the cover component and channels which extend a greater distance into the actuator component may be equalised by choosing appropriate depths and thereby appropriate cross-sectional areas of channels. In this embodiment, the velocity may be equalised at around 7.5 m/s where the 550 μm channel length is formed by 215 μm and 335 μm in the cover component and actuator component and respectively with alternate channels extending 335 μm and 215 μm in the cover component and actuator component and respectively. It will be understood that there is an optimum channel configuration for other depths and widths of channels.

A further benefit of the offset channels is that a high frequency can be maintained yet the problems of starvation, i.e. where ink is ejected from the ejection channel at such a rate that the supply of ink to the ejection channel is interrupted, can be reduced through the provision of an ejection channel of a greater cross-sectional area.

The offset-channel printheads with monolithic cantilever design as shown in FIG. 14 require a higher driving voltage for the lower channels than a chevron offset channel print head as used in the previously described embodiments and as depicted for comparison in FIG. 9. Here the actuator component 300 is formed by two laminated plates of PZT 320,322.

The glue joint between the two oppositely poled PZT materials is positioned at the centre of the movable parts of the channel walls and the movable parts of the channel walls are fully covered with electrodes. Measurements revealed that a Chevron design compared with a monolithic design of identical offset-channel depth yielded highly increased efficiency in drop formation, and allowed to reduce the driving voltage by more than 10 V.

It has now been found that it is possible to increase the ejection characteristics further by modifying the acoustic reflection coefficient of the actuator channels. FIG. 16 depicts the situation where an acoustic reflection chamber 325 is formed in the actuator component. FIG. 17 depicts the situation where the acoustic reflection chamber is formed by an acoustically transparent glue layer 330 extending a distance between 10 μm and 1000 μm along the length of the channel, the distance may be selected by routine experimentation to achieve the required acoustic reflection.

The actuator plate is manufactured according to the steps depicted in FIGS. 18 and 19. A support 430 of a material thermally matched to that of the active PZT 432 is provided with a flat portion 434 onto which the PZT or laminate PZT is mounted. The PZT is glued to the support by glue 436 that is acoustically transparent to the ink that will be used in the actuator. By acoustically transparent it is meant that a body of glue provides the same acoustic reflection coefficient as a body of ink. The glue should be chemically inert with the ink. The depth of glue between the rear of the PZT and the support is preferably greater than the depth of glue between the base of the PZT and the support as this provides a stiff join to the support yet a high acoustic reflection coefficient.

An appropriate thickness of glue at the rear of the PZT actuator provides the required acoustic reflection coefficient. Channels 438 are sawn which extend through the PZT and the glue and into the support. Epoxy glues are particularly appropriate.

The velocities of ink droplets between the upper channels (greater extension of the channel into the cover component) and the lower channels (greater extension of the channel into the actuator component) may be equalised by applying what may be known as a 2-cycle, 2-phase firing sequence. The adjacent upper channels are actuated in the first cycle and first phase of the actuation sequence at a first voltage. The lower channels are actuated in the second phase and second cycle of the print head at the greater voltage that is required to ensure equality in the ejection characteristics of the upper and lower channels. This technique may be used even where the acoustic reflection characteristics are modified as described above. As previously noted, alternatives to the use of different voltages are different pulse rises or different pulse widths.

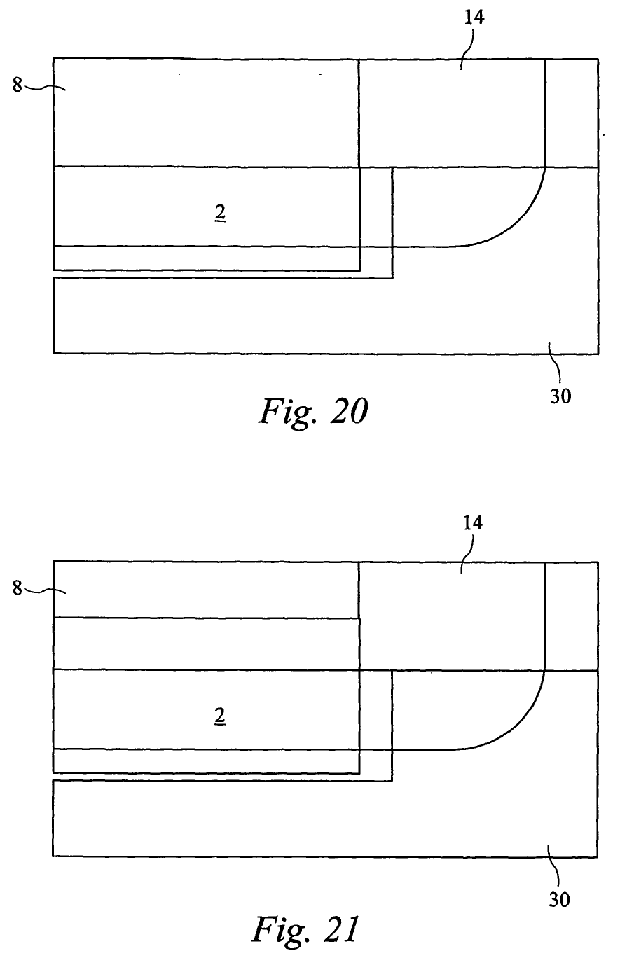

Forming the actuator component in this way and in this structure provides all the benefits of a run-out i.e. a variable depth portion at the rear of the ejection channel in terms of manufacturability e.g. dicing and sawing and electrical connection with an improvement in the acoustic reflection coefficient. This aspect of the actuator has been described with reference to off-set channels however, the modifications relating to an improved acoustic boundary in the actuator channels may equally apply to channels not having an offset e.g. in FIG. 20, where the cover component does not have channels and FIG. 21, where the cover component is provided with channels. Channels provided in the cover provide a greater efficiency and reduced cross talk over channels formed solely in the actuator component.

Whilst the invention has been illustrated with odd channels forming one group and the even channels forming the other, offset group, alternative grouping arrangements will be evident to the skilled reader. This is but one of a large number of modifications that may be made without departing form the scope of the invention as set forth in the appended claims Each feature described in the specification or claims may be combined with any other feature or features described in the specification or claims without departing from the invention described herein.

1. Droplet deposition apparatus comprising a body structure defining a central plane and in that plane a channel extension direction; a plurality of elongate droplet ejection channels extending through the body structure parallel to the central plane and in the channel extension direction, each channel being offset relative to the central plane with respect to the adjacent channel; a respective droplet ejection nozzle communicating with each channel; an actuator for generating an acoustic wave in a selected channel and thereby effecting drop ejection through the respective nozzle; a manifold extending through the body structure parallel to the central plane and orthogonal to the channel extension direction, the manifold intersecting each channel to define a channel end profile, the channel end profile of one channel being substantially a mirror image in the central plane of the channel end profile of the adjacent channel, so that the acoustic wave refection coefficient of the boundary between each channel and the manifold is substantially equal for all channels.

2. Droplet deposition apparatus according to claim 1, wherein each channel end profile includes a profile surface which is inclined with respect to the channel extension direction, the angle of inclination of the profile surface for one channel being equal and opposite to that of the adjacent channel.

3. Droplet deposition apparatus according to claim 1, wherein an electrically conductive track extends over part of the channel end profile for each channel.

4. Droplet deposition apparatus according to claim 3, wherein said electrically conductive tracks are formed by through deposition of a continuous conductive layer and subsequent removal of material to delineate tracks.

5. Droplet deposition apparatus according to claim 4, wherein said material is removed in a laser process.

6. Droplet deposition apparatus comprising a body structure defining a central plane and in that plane a channel extension direction; a plurality of elongate droplet ejection channels extending through the body structure parallel to the central plane and in the channel extension direction, a first group of channels being offset relative to the central plane in a first offset direction orthogonal to the central plane and a second group of channels being offset relative to the central plane in a second offset direction orthogonal to the central plane; a respective droplet ejection nozzle communicating with each channel; actuators comprising respective regions of piezoelectric material with electrodes connected to receive drive signals, each actuator on receipt of a drive signal serving to generate an acoustic wave in a selected channel and thereby effect drop ejection through the respective nozzle; a manifold extending through the body structure parallel to the central plane and orthogonal to the channel extension direction, the manifold intersecting each channel to define a channel end profile, with a conductive track extending over at least part of the channel end profile of each channel, the conductive tracks carrying drive signals to the electrodes, the channel end profile of the first group of channels being substantially a mirror image in the central plane of the channel end profile of the second group of channels, so that the acoustic wave refection coefficient of the boundary between each channel and the manifold is substantially equal for all channels.

7. Droplet deposition apparatus according to claim 6, wherein the cross section of the manifold is symmetric with respect to the central plane.

8. Droplet deposition apparatus according to claim 6, further comprising a first electrical drive circuit for providing a first drive waveform for actuating channels of the first group of channels and a second electrical drive circuit for providing a second drive waveform for actuating channels of the second group of channels, the first and second groups of channels being actuated alternately and the first drive waveform differing from the second drive waveform to that extent necessary to ensure equal velocity of drop ejection from a channel of the first group and a channel of the second group.

9. Droplet deposition apparatus according to claim 8, wherein the first drive waveform differs from the second drive waveform in drive voltage, in pulse rise or in pulse width.

10. Droplet deposition apparatus comprising a body structure defining a central plane and in that plane a channel extension direction; a plurality of elongate droplet ejection channels extending through the body structure parallel to the central plane and in the channel extension direction, a first group of channels being offset relative to the central plane in a first offset direction orthogonal to the central plane and a second group of channels being offset relative to the central plane in a second offset direction orthogonal to the central plane; a respective droplet ejection nozzle communicating with each channel; electrically actuable actuators for generating an acoustic wave in a selected channel and thereby effecting droplet ejection through the respective nozzle; a manifold extending through the body structure parallel to the central plane and orthogonal to the channel extension direction, the manifold intersecting each channel, with the first group of channels having an acoustic wave reflection coefficient at the manifold which differs from the acoustic wave reflection coefficient at the manifold of the second group of channels; a first electrical drive circuit for providing a first drive waveform for actuating channels of the first group of channels and a second electrical drive circuit for providing a second drive waveform for actuating channels of the second group of channels, the first and second groups of channels being actuated alternately and the first drive waveform differing from the second drive waveform in that extent necessary to ensure equal velocity of drop ejection from a channel of the first group and a channel of the second group.

11. Droplet deposition apparatus according to claim 10, wherein the first drive waveform differs from the second drive waveform in drive voltage, in pulse rise or in pulse width.

12. A method of droplet deposition comprising the steps of providing a body structure defining a central plane and in that plane a channel extension direction; a plurality of elongate droplet ejection channels extending through the body structure parallel to the central plane and in the channel extension direction, each channel being offset relative to the central plane with respect to the adjacent channel; a respective droplet ejection nozzle communicating with each channel; and a manifold extending through the body structure parallel to the central plane and orthogonal to the channel extension direction, the manifold intersecting each channel to define a channel end profile; generating an acoustic wave in a first channel and thereby effecting drop ejection through the respective nozzle; generating an acoustic wave in a second channel adjacent to the first channel and thereby effecting drop ejection through the respective nozzle; and arranging that the acoustic wave refection coefficient of the boundary between the first channel and the manifold is equal to that of the boundary between the second channel and the manifold.

13. A method according to claim 12, wherein each channel end profile includes a profile surface which is inclined with respect to the channel extension direction, the angle of inclination of the profile surface for one channel being equal and opposite to that of the adjacent channel.

14 (canceled)

15 (canceled)

16. Droplet deposition apparatus comprising an actuator plate comprising a plurality of channels at a predetermined channel spacing, each of said channels having a predetermined length d1 a portion of said length having a constant depth and a portion of said length having a changing depth; a nozzle plate providing an end wall of said actuator channels and said cover channels; wherein said actuator channels comprise acoustic reflection modifying means.

17. Droplet deposition apparatus comprising an actuator plate comprising a plurality of channels at a predetermined channel spacing, each of said channels having a predetermined length d1 a portion of said length having a constant depth and a portion of said length having a changing depth; a cover plate comprising a plurality of channels at a predetermined channel spacing and having a channel length d2, where d2 is less than d1; at least one of said actuator channels being in registry with at least one of said cover channels; a nozzle plate providing an end wall of said actuator channels and said cover channels; wherein at least some of said actuator channels comprise an acoustic reflection modifier such that the acoustic reflection of an ejection channel formed of an actuator channel in registry with a cover channel is substantially identical to the acoustic reflection of an ejection channel formed of an actuator channel which is not in registry with a cover channel.

18. Apparatus according to claim 16, wherein the acoustic reflection modifier comprises a groove extending transverse to the length of the actuator channels.

19. Apparatus according to claim 18, wherein the transverse groove is filled with an ejection fluid.

20. Apparatus according to claim 18, wherein the transverse groove is filled with an acoustically transparent solid.

21. Apparatus according to claim 20, wherein the acoustically transparent solid is an adhesive material.

22. Droplet deposition apparatus according to claim 8, wherein the cross section of the manifold is symmetric with respect to the central plane.

23. Apparatus according to claim 17, wherein the acoustic reflection modifier comprises a groove extending transverse to the length of the actuator channels.

24. Apparatus according to claim 23, wherein the transverse groove is filled with an injection fluid.

25. Apparatus according to claim 23, wherein the transverse groove is filled with an acoustic transparent solid.

26. Apparatus according to claim 25, wherein the acoustically transparent solid is an adhesive material.

27. Apparatus according to claim 26, wherein the acoustically transparent solid is an epoxy.

28. Apparatus according to claim 21, wherein the acoustically transparent solid is an epoxy.
